(19) United States
(12) Patent Application Publication
(10) Pub. No.: US 2011/0210683 A1
(43) Pub. Date: Sep. 1, 2011

(54) Controlling Information Presentation by an Apparatus

(76) Inventor: William Smith, Kanunki (FI)

(21) Appl. No.: 12/739,197

(22) PCT Filed: Oct. 25, 2007
(86) PCT No.: PCT/EP07/09267

§ 371 Date: Jul. 1, 2010

(51) Int. Cl. H05B 37/00

(52) U.S. Cl. 315/312

(57) ABSTRACT

An apparatus including: an arrangement of light emitting elements; a memory for storing an activation pattern for the arrangement of light emitting elements; a movement detector; and a processor configured to traverse the activation pattern across the arrangement of light emitting elements in response to detected movement of the apparatus.

### FIELD OF THE INVENTION

Embodiments of the present invention relate to controlling information presentation.

### BACKGROUND TO THE INVENTION

Some apparatus are able to present information to a user or bystander in a number of different ways using for example loudspeakers, alarms, displays, warning lights, vibration alerts etc. Typically apparatus have man-machine-interfaces that enable a user to control the presentation of information.

There are probably still many as yet undiscovered mechanisms for presenting information and for controlling how that information is varied.

### BRIEF DESCRIPTION OF VARIOUS EMBODIMENTS OF THE INVENTION

The inventors have devised a new mechanism for controlling the presentation of information.

According to various embodiments of the invention there is provided an apparatus comprising: an arrangement of light emitting elements; a memory for storing an activation pattern for the arrangement of light emitting elements; a movement detector; and a processor configured to traverse the activation pattern across the arrangement of light emitting elements in response to detected movement of the apparatus.

According to various embodiments of the invention there is provided a user interface for an apparatus comprising: a multi-dimensional arrangement of light emitting elements; control means for selectively activating individual ones of the light emitting elements according to a multi-dimensional activation pattern for the arrangement of light emitting elements, wherein the multi-dimensional activation pattern traverses across the multi-dimensional arrangement of light emitting elements in response to movement of the apparatus.

According to various embodiments of the invention there is provided a method comprising: using at a first location, a first portion of an activation pattern to selectively activate light emitting elements in a multi-dimensional arrangement of light emitting elements; using at a second location a second different portion of the activation pattern to selectively activate light emitting elements in the multi-dimensional arrangement of light emitting elements; using at a third location a third different portion of the activation pattern to selectively activate light emitting elements in the multi-dimensional arrangement of light emitting elements; and using at a fourth location a fourth different portion of the activation pattern to selectively activate light emitting elements in the multi-dimensional arrangement of light emitting elements computer program product embodied on a computer readable medium comprising: instructions for providing an interface configured to access motion data and a data structure that defines an activation pattern for an arrangement of light emitting elements; and instructions that process the motion data to change a selected portion of the activation pattern from a first portion to a second portion and instructions that use the selected portion to determine and output control data configured to control a multi-dimensional arrangement of light emitting elements.

According to various embodiments of the invention there is provided a hand-portable personal electronic device comprising: an arrangement of colored light emitting diodes; a displacement detector; and a processor configured to automatically select a portion of an activation pattern for use in controlling the arrangement of colored light emitting diodes wherein the selected portion is a first portion at a first time and the selected portion is a second portion at a second time and wherein the displacement of the second portion relative to the first portion within the activation pattern is defined by the change in displacement of the hand-portable electronic device between the first and second times.

### BRIEF DESCRIPTION OF THE DRAWINGS

For a better understanding of various embodiments of the present invention reference will now be made by way of example only to the accompanying drawings in which:

FIGS. 1A and 1B schematically illustrate different embodiments of an apparatus;

FIG. 2 schematically illustrates a hand-portable personal electronic device embodiment of the apparatus;

FIG. 3 schematically illustrates an example of one arrangement of light emitting elements;

FIG. 4A schematically illustrates an activation pattern a portion of which is used to control the activation of the arrangement of light emitting elements illustrated in FIG. 4B;

FIG. 5A schematically illustrates an activation pattern a portion of which is used to control the activation of the arrangement of light emitting elements illustrated in FIG. 5B; and

FIG. 6 schematically illustrates a computer program product.

### DETAILED DESCRIPTION OF VARIOUS EMBODIMENTS OF THE INVENTION

The Figs illustrate an apparatus that traverses an activation pattern across an arrangement of light emitting elements in response to movement of the apparatus. The activation pattern may define an image, picture, text, or a repeat pattern for example, which is scrolled through the arrangement of light emitting elements by moving the apparatus.

An activation pattern defines for each one of the individual light emitting elements in the arrangement of light emitting elements whether a particular light emitting element is activated and, possibly depending on implementation, as an addition or as an alternative, the intensity and/or color of activation.

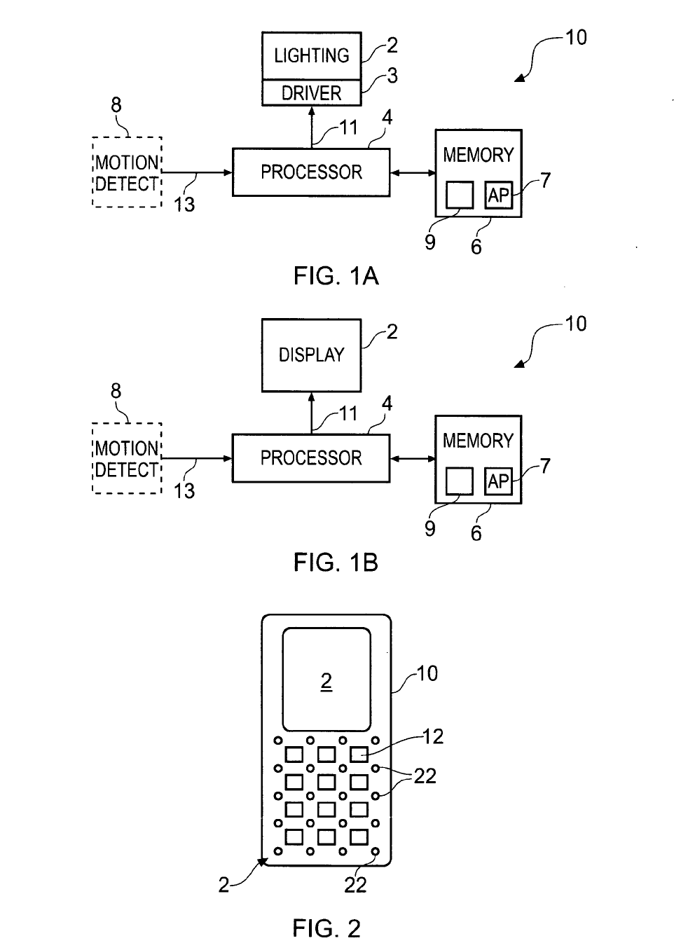

FIGS. 1A and 1B schematically illustrate an apparatus 10 comprising: a user output device 2 that comprises an arrangement of light emitting elements; a memory 6; a processor 4 and a motion detector 8.

The processor 4 is arranged to read from and write to the memory 6 and is arranged to receive motion data 13 from the motion detector 8 and provide control data 11 to the user output device 2.

The user output device 2 is a part of a user interface for the apparatus 10.

The motion detector 8 is used to detect the extent of movement of the apparatus 10. The motion detector 8 may, for example, detect position/location, velocity, acceleration. Any one of these kinematic parameters represents the extent of motion of the apparatus.

The motion detector 8 may be a hardware motion detector, such as an accelerometer, a gyroscope (e.g. a piezo electric gyroscope or a laser gyroscope) or a satellite positioning receiver, or a software motion detector such as a software module run on processor 4 that determines position by, for example, triangulation of signals received for another purpose.

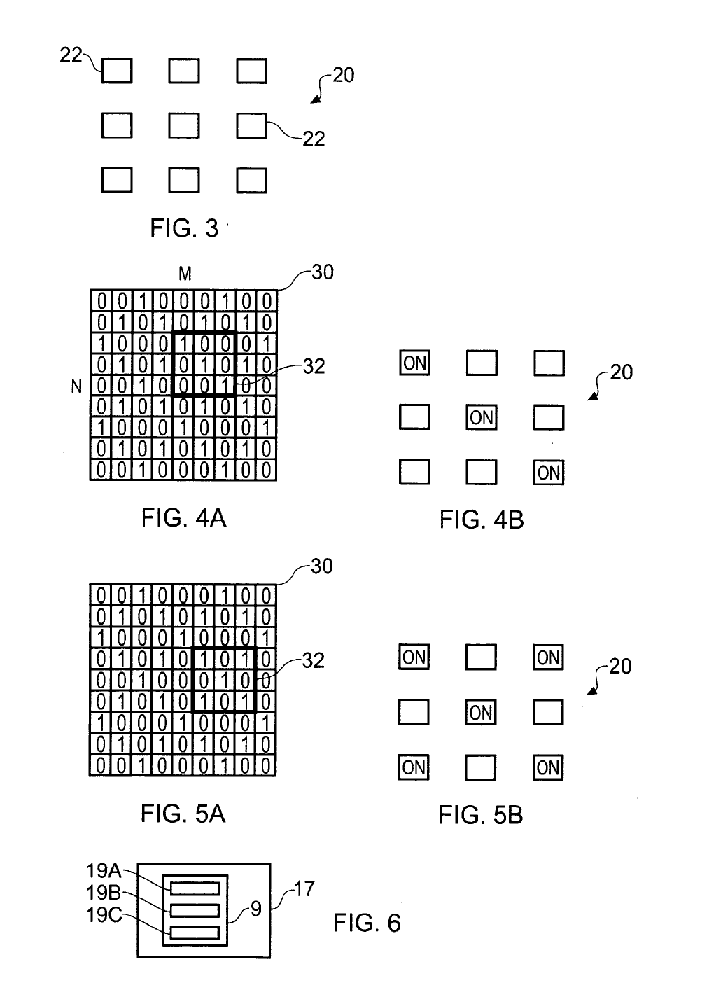

An arrangement of light emitting elements is such that the light emitting elements are distributed over an area (or volume) as opposed to being arranged only in a rectilinear line. An example of one arrangement 20 of light emitting elements 22 is illustrated schematically in FIG. 3.

In the illustrated example, the arrangement 20 is a two dimensional arrangement. It has an m by n array of regularly spaced light emitting elements 22. The array that has m columns and n rows.

A controller such as a driver 3 may be used to control the arrangement of light emitting elements. The controller selectively activates individual ones of the light emitting elements according to control data 11 provided by the processor 4.

The control data 11 is derived by processor 4 from an activation pattern which may be stored as a data structure 7 in the memory 6. The memory 6 also stores a computer program 9.

The light emitting elements 22 may be used to provide ambient lighting 2 as illustrated in FIG. 1A.

The light emitting elements 22 may alternatively be pixels of a display as illustrated in FIG. 1B.

The lighting elements 22 may, for example, be light emitting diodes as, for example, illustrated in FIG. 2. In FIG. 2, the apparatus 10 is a hand-portable personal electronic device such as a mobile cellular telephone or a personal music player. The light emitting diodes are used to illuminate the keys 12 of the key pad. They may, for example, provide front lighting or backlighting.

The apparatus 10 may comprise a module that is integrated into a housing possibly with additional components to form a final product. Such a module may comprise the processor 4 and memory 6 and may or may not comprise the motion detector 8.

As used here ‘module’ refers to a unit or apparatus that excludes certain parts/components that would be added by an end manufacturer or a user.

An example of an activation pattern 30 is illustrated in FIGS. 4A and 5A. In this example, the activation pattern 30 defines a value p for at least each one of the individual light emitting elements 22 in the arrangement 20 of light emitting elements illustrated in FIG. 3. A value indicates whether a light emitting element 22 assigned to that value is activated and, possibly depending on implementation, the intensity and/or color of activation. A value may be, for example, a binary value such as on/off, a scalar value such as a greyscale intensity, or a vector value such as a co-ordinate in a color space (RGB, YUV etc).

The illustrated activation pattern 30 may be defined as an N row by M column matrix P having individual entries p(i,j) for i=1, 2 . . . M, j=1, 2 . . . N.

The window 32 illustrates the portion of the activation pattern 30 that provides the control data 11 that controls the arrangement 20 of light emitting elements 22. The control data 11 has values a(x, y) defined by a(x,y)=p(I+x, J+y), where (I,J) represents the position of a window 32 of size m×n within the activation pattern 30 and x=0, 1, 2 . . . m, y=0, 1, 2 . . . n, where m<M and n<N.

In the illustrated examples, M=9, N=9, m=3, n=3.

In FIG. 4A, I=5, J=5, and the control data 11 is:

a(0,0)=p(I,J)=p(5,5) a(1,0)=p(I+1,J)=p(6,5) a(2,0)=p(I+2,J)=p(7,5)

a(0,1)=p(I,J+1)=p(5,6) a(1,1)=p(I+1,J+1)=p(6,6) a(2,1)=p(I+2,J+1)=p(7,6)

a(0,2)=p(I,J+2)=p(5,7) a(1,2)=p(I+1,J+2)=p(6,7) a(2,2)=p(I+2,J+2)=p(7,7)

In FIG. 4B, I=6, J=4, and the control data 11 is:

a(0,0)=p(I,J)=p(6,4) a(1,0)=p(I+1,J)=p(7,4) a(2,0)=p(I+2,J)=p(8,4)

a(0,1)=p(I,J+1)=p(6,5) a(1,1)=p(I+1,J+1)=p(7,5) a(2,1)=p(I+2,J+1)=p(8,5)

a(0,1)=p(I,J+1)=p(6,6) a(1,1)=p(I+1,J+1)=p(7,6) a(2,1)=p(I+2,J+1)=p(8,6)

The processor 4 is configured to traverse or scroll the activation pattern 30 across the arrangement 20 of light emitting elements 22 in response to detected movement of the apparatus 10.

Referring back to the example of FIGS. 4A and 5A, the processor 4 may be configured to select the portion of the activation pattern 30 within the window 32 for use as control data 11. The processor 4 may be configured to move the window 32 over the activation pattern 30 by modifying I and J in response to motion data 13 received from the motion detector 8.

For example, increasing I traverses the window 32 to the right in the Figs which is equivalent to traversing the activation pattern to the left. Decreasing I will traverse the pattern to the right.

Increasing J traverses the window 32 upwards in the Figs which is equivalent to traversing the activation pattern downwards. Decreasing I will traverse the pattern to the upwards.

If the location of the device according to motion data 13 is given by L, e.g. a Cartesian co-ordinate (a,b,c) then it is possible to define a transformation function F utilized by the processor 4 such that I and J are dependent upon L.

For example:

I=k1*a−A, where A is a constant

J=k2*b−B, where B is a constant

maps changes in the location of the device within the a-b plane to a proportional change in location of the window 32 within the allocation pattern 30.

The values of k1 and k2 may be fixed or variable. They may be chosen, for example, so that if the arrangement 20 of light emitting elements 22 is oriented so that it lies in the a-b plane, then translational movement of the apparatus 10 within the a-b plane results in equivalent translational movement of the window 32 within the allocation pattern 30.

As the portion of the allocation pattern within the window 32 is used to control the arrangement of light emitting elements, the correct selection of k1 and k2, will result in the appearance that the apparatus is being moved ‘over’ the allocation pattern in real space.

This may be appreciated with reference to FIGS. 4A, 4B, 5A and 5B.

Referring to FIGS. 4A and 4B, when the apparatus is at a first location (α, β) in the a-b plane, a first portion 32 of an activation pattern 30 is used to selectively activate light emitting elements 22 in the arrangement 20 of light emitting elements 22. Referring to FIGS. 5A and 5B, when the apparatus is at a second location (α+k1, β−k2) in the a-b plane, a second portion 32 of the activation pattern 30 is used to selectively activate light emitting elements 22 in the arrangement 20 of light emitting elements 22.

The displacements of the second portion from the first portion are (1, −1) which are proportional to the displacements of the second location from the first location (k1, −k2).

It will be appreciated that as the apparatus is moved to third and fourth locations in the real world the window 32 is moved to define third and fourth portions of the activation pattern 30.

The activation pattern may define an image or picture, text, or a repeat pattern for example, which is scrolled across the arrangement 20 of light emitting elements 22 by moving the apparatus 10.

The activation pattern may be defined in the memory 6 as a bitmap or as a function, for example.

In the preceding example, the arrangement of light emitting elements illustrated in FIGS. 3, 4B and 5B are arranged as a two-dimensional array and the activation pattern 30 illustrated in FIGS. 4A and 5A are arranged as a two-dimensional array.

It should be appreciated that the activation pattern used with the two-dimensional arrangement of light emitting elements could be replaced with a three-dimensional arrangement that has a depth. The depth dimension could then be traversed with movement of the apparatus 10 perpendicular to the a-b plane in the c-direction. It should also be appreciated, that the arrangement of light emitting elements may be a three-dimensional arrangement of light emitting elements such that light emitting elements are distributed over a volume. The activation pattern in this case would typically also be three dimensional.

The memory 6 also stores a computer program 9.

The memory 6 stores computer program instructions 9 that control the operation of the apparatus 10 when loaded into the processor 4. The computer program instructions 9 provide the logic and routines that enables the apparatus to perform the movement-dependent scrolling of an activation pattern across the arrangement of light emitting elements.

The computer program instructions may arrive at the apparatus via an electromagnetic carrier signal or be copied from a computer readable physical medium 17 such as a computer program product, a memory device or a record medium such as a CD-ROM or DVD. The electronic may propagate or transmit the computer program as a computer data signal.

The computer program 9 embodied on the computer readable medium is illustrated in FIG. 6. It comprises: instructions 19A that provide an interface; instructions 19B that process the motion data; and instructions 19C that that determine and output control data 11.

The instructions 19A provide an interface. The interface is configured to access motion data 13 and the data structure 7 that defines the activation pattern 30 for the arrangement of light emitting elements.

The instructions 19A process the motion data 13 to change a selected portion 32 of the activation pattern 30 from a first portion to a second portion. A pre-defined transformation displaces the selected portion 32 from the first portion to the second portion in accordance with the motion data 13.

The instructions 19C use the selected portion 32 to determine and output control data 11 that is configured to control the arrangement 20 of light emitting elements 22.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. An apparatus comprising:
an arrangement of light emitting elements;
a memory for storing an activation pattern for the arrangement of light emitting elements;
a movement detector; and
a processor configured to traverse the activation pattern across the arrangement of light emitting elements in response to detected movement of the apparatus.

2. An apparatus as claimed in claim 1, wherein the processor is configured to traverse the activation pattern across the arrangement of light emitting elements at a rate and in a direction dependent upon movement of the apparatus.

3. An apparatus as claimed in claim 2, wherein the processor is configured to traverse the activation pattern in a direction opposite to the detected displacement of the apparatus.

4. An apparatus as claimed in claim 3, wherein the processor is configured to traverse the activation pattern an amount that is linearly proportional to a detected displacement of the apparatus.

5. An apparatus as claimed in claim 2, wherein the arrangement of light emitting elements is a multi-dimensional arrangement of light emitting elements such that light emitting elements are distributed over an area or volume and the activation pattern is a multi-dimensional activation pattern.

6. An apparatus as claimed in claim 1, wherein the processor is configured to provide motion dependent scrolling of the activation pattern across the arrangement of light emitting elements.

7. An apparatus as claimed in claim 6, wherein the arrangement of light emitting elements is a two-dimensional arrangement of light emitting elements such that light emitting elements are distributed over an area.

8. An apparatus as claimed in claim 6, wherein the arrangement of light emitting elements is a three-dimensional arrangement of light emitting elements.

9. An apparatus as claimed in claim 1, wherein an activation pattern comprises a plurality of co-ordinates in a color space.

10. An apparatus as claimed in claim 1, wherein the motion detector comprises a hardware accelerometer.

11. An apparatus as claimed in claim 1, wherein the motion detector comprises a gyroscope.

12. An apparatus as claimed in claim 1, wherein the light emitting elements are light emitting diodes.

13. An apparatus as claimed in claim 1, wherein the light emitting elements backlight a keypad of a hand held apparatus.

14. An apparatus as claimed in claim 1, wherein the light emitting elements are pixels of a display

15. (canceled)

16. (canceled)

17. (canceled)

18. A method comprising:
using at a first location, a first portion of an activation pattern to selectively activate light emitting elements in a multi-dimensional arrangement of light emitting elements;
using at a second location a second different portion of the activation pattern to selectively activate light emitting elements in the multi-dimensional arrangement of light emitting elements;
using at a third location a third different portion of the activation pattern to selectively activate light emitting elements in the multi-dimensional arrangement of light emitting elements; and
using at a fourth location a fourth different portion of the activation pattern to selectively activate light emitting elements in the multi-dimensional arrangement of light emitting elements

19. A method as claimed in claim 18, wherein there is a connecting relationship between the first, second, third and fourth locations and the positions of the first, second, third and fourth portions of the activation pattern within the activation pattern and wherein the connecting relationship identifies which portion of the activation pattern is used at a fifth location to selectively activate light emitting elements in the multi-dimensional arrangement of light emitting elements.

20. A method as claimed in claim 18, wherein the activation pattern traverses across the multi-dimensional arrangement of light emitting elements at a rate and in a direction dependent upon movement of the apparatus.

21. A method as claimed in claim 18, wherein the activation pattern is configured to traverse across the multi-dimensional arrangement of light emitting elements by an amount that is linearly proportional to a detected displacement of the apparatus and in a direction opposite to the detected displacement of the apparatus.

22. (canceled)

23. (canceled)

24. (canceled)

25. A hand-portable personal electronic device comprising:
an arrangement of colored light emitting diodes;
a displacement detector; and
a processor configured to automatically select a portion of an activation pattern for use in controlling the arrangement of colored light emitting diodes wherein the selected portion is a first portion at a first time and the selected portion is a second portion at a second time and wherein the displacement of the second portion relative to the first portion within the activation pattern is defined by the change in displacement of the hand-portable electronic device between the first and second times.
